(19) United States
(12) Patent Application Publication
(10) Pub. No.: US 2018/0294875 A1
(43) Pub. Date: Oct. 11, 2018

(54) NETWORK CONTROL APPARATUS, NETWORK CONTROL METHOD, AND STORAGE MEDIUM

(71) Applicant: FUJITSU LIMITED, Kawasaki-shi (JP)

(72) Inventor: SATORU OKANO, Yokohama (JP)

(73) Assignee: FUJITSU LIMITED, Kawasaki-shi (JP)

(21) Appl. No.: 15/939,925

(22) Filed: Mar. 29, 2018

(30) Foreign Application Priority Data
Apr. 5, 2017 (JP) 2017-074932

(51) Int. Cl. H04B 10/079; H04Q 11/00

(52) U.S. Cl. CPC H04B 10/07953; H04B 10/07955; H04Q 2011/0073; H04Q 2011/0083; H04Q 11/0066

(57) ABSTRACT

A network control apparatus includes a memory that stores route information indicating a route of a path established in a network; and a processor coupled to the memory and configured to determine a target node of which signal output power is to be adjusted among a plurality of nodes on the route included in the route information, based on a signal quality between the plurality of nodes on the route; and instructs the determined target node to adjust the signal output power.

### CROSS-REFERENCE TO RELATED APPLICATION

This application is based upon and claims the benefit of priority of the prior Japanese Patent Application No. 2017-74932, filed on Apr. 5, 2017, the entire contents of which are incorporated herein by reference.

### FIELD

The embodiments discussed herein are related to a network control apparatus, a network control method, and a storage medium.

### BACKGROUND

Regarding optical networks, long-distance and large-capacity optical transmission has been developed by the practical use of wavelength division multiplexing (WDM). In addition, optical network topologies have been expanded from linear configurations in which nodes are connected to each other in a point-to-point manner to ring configurations in which nodes are connected to each other in loop forms and mesh configurations in which nodes are connected to each other in mesh forms. As related art, Japanese Laid-open Patent Publication No. 2016-072834, Japanese Laid-open Patent Publication No. 2010-200059, and the like have been disclosed.

In optical paths established between nodes of an optical network, various transmission patterns (differences between transmission distances, types of signal modulation, and the like) of the optical paths exist. In the design of the optical network, optical output power is set for each of channels in such a manner that optical signal-to-noise ratios (OSNRs) are equal to each other in all the optical paths established between the nodes regardless of the channels in order to support these transmission patterns.

In the case where the optical output power is set in such a manner that the OSNRs are equal to each other, an optical path that does not satisfy a desirable OSNR exists. Thus, the desirable OSNR may be satisfied in this optical path by installing a regenerator in a node installed on the optical path.

In the design of this optical network, the number of nodes in which regenerators are to be installed may increase due to the expansion of the topology of the optical network. Due to an increase in the number of regenerators to be installed, the cost (network cost) of building the optical network increases. Under such circumstances, it is desirable to suppress the network cost.

### SUMMARY

According to an aspect of the invention, a network control apparatus includes a memory that stores route information indicating a route of a path established in a network; and a processor coupled to the memory and configured to determine a target node of which signal output power is to be adjusted among a plurality of nodes on the route included in the route information, based on a signal quality between the plurality of nodes on the route; and instructs the determined target node to adjust the signal output power.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a network control apparatus;

FIG. 2 is a diagram illustrating an example of a configuration of an optical network;

FIG. 3 is a diagram illustrating an example of the expansion of an optical network topology;

FIG. 4 is a diagram illustrating an example of the establishment of optical paths in an optical network;

FIG. 5 is a diagram describing an example of a state in which a regenerator is installed;

FIG. 6 is a diagram describing an example of the state in which the regenerator is installed;

FIG. 7 is a diagram illustrating an example of the configuration of a network control system;

FIG. 8 is a diagram illustrating an example of a hardware configuration of a network control apparatus;

FIG. 9 is a diagram illustrating an example of functional blocks of the network control apparatus;

FIG. 10 is a diagram illustrating an example of a configuration of a node;

FIG. 11 is a diagram illustrating an example of the adjustment of optical output power;

FIG. 12 is a flowchart of an example of operations of the network control apparatus;

FIG. 13 is a flowchart of an example of operations of the network control apparatus;

FIG. 14 is a diagram illustrating an example of a configuration of an optical network;

FIG. 15 is a diagram illustrating an example of a route table;

FIG. 16 is a diagram illustrating an example of a margin management table;

FIG. 17 is a diagram illustrating an example of a negative margin extraction table;

FIG. 18 is a diagram illustrating an example of sections of an optical path;

FIG. 19 is a diagram illustrating an example of a section index management table;

FIG. 20 is a diagram illustrating an example of a reduction target path management table;

FIG. 21 is a diagram illustrating an example of the amount of an increase in optical output power; and

FIG. 22 is a diagram illustrating an example of the amount of a reduction in optical output power.

### DESCRIPTION OF EMBODIMENTS

Embodiments are described with reference to the accompanying drawings.

### First Embodiment

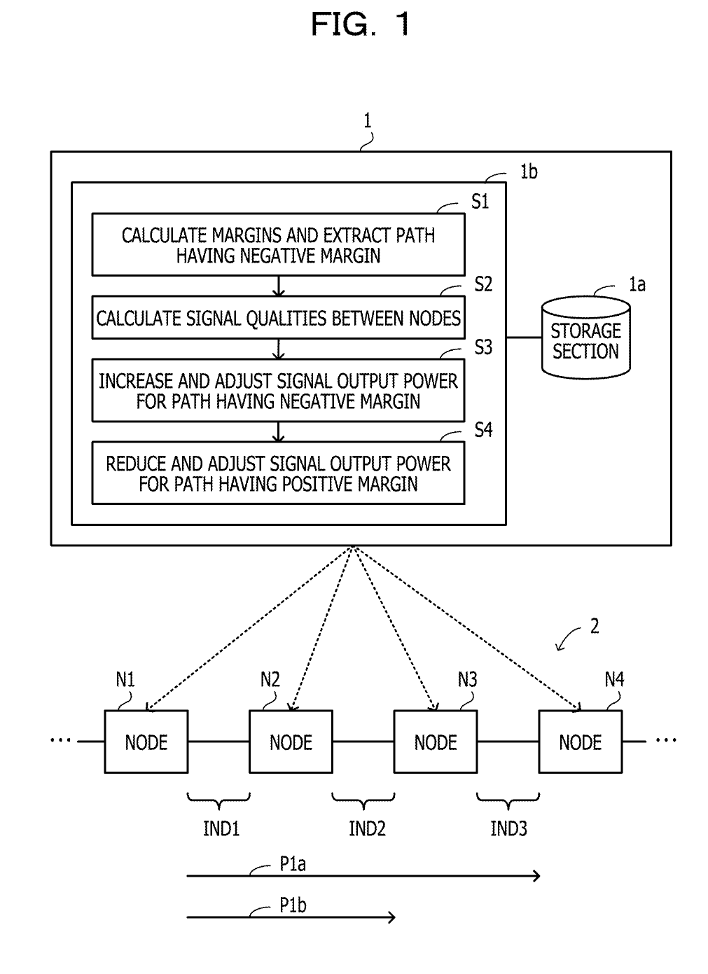

A first embodiment is described below. FIG. 1 is a diagram illustrating an example of a configuration of a network control apparatus. A network control apparatus 1 includes a storage section 1a and a controller 1b. The storage section 1a stores routes of paths established in a network 2.

The controller 1b determines, based on a signal quality between nodes on a route, a target node that is among the nodes on the route and of which signal output power is to be adjusted. Then, the controller 1b instructs the target node to adjust the signal output power.

The network 2 includes nodes N1, . . . , and N4 connected to each other in a linear manner. The network control apparatus 1 is connected to one or more of the nodes N1, . . . , and N4. Upon receiving the adjustment instruction notified by the network control apparatus 1, a node connected to the network control apparatus 1 transmits the adjustment instruction to the target node.

In the network 2, a path P1a is established between the node N1 and the node N4 and extends from the node N1 to the node N4, and a path P1b is established between the node N1 and the node N3 and extends from the node N1 to the node N3. Route information of the paths is stored in the storage section 1a.

In S1, the controller 1b calculates a subtracted value (hereinafter referred to as margin) obtained by subtracting a signal-to-noise ratio limit of the node N4 from a signal-to-noise ratio of the node N4 on the path P1a established in the network 2. The controller 1b calculates a margin by subtracting a signal-to-noise ratio limit of the node N3 from a signal-to-noise ratio of the node N3 on the path P1a established in the network 2.

Then, the controller 1b extracts a path having a negative margin. This example assumes that the path P1a has a negative margin. Specifically, this example assumes that the signal-to-noise ratio of the terminal node N4 of the path P1a is lower than the signal-to-noise ratio limit of the node N4 and that a signal level of the path P1a is insufficient.

The example assumes that the path P1b has a positive margin (the signal-to-noise ratio of the terminal node N3 of the path P1b is higher than the signal-to-noise ratio limit of the node N3).

In S2, the controller 1b calculates signal qualities (for example, signal-to-noise ratios) between the nodes of the path P1a. Specifically, the controller 1b calculates a signal quality IND1 between the nodes N1 and N2, a signal quality IND2 between the nodes N2 and N3, and a signal quality IND3 between the nodes N3 and N4.

The controller 1b gives priorities to sections between the pairs of adjacent nodes in ascending order of signal quality value (or in descending order of the degree of reduction in signal quality). If the signal qualities have relationships of IND1<IND2<IND3, a priority given to a section between the nodes N1 and N2 is set to the highest priority, a priority given to a section between the nodes N2 and N3 is set to the next highest priority, and a priority given to a section between the nodes N3 and N4 is set to the lowest priority.

In S3, the controller 1b increases and adjusts signal output power in order from the highest priority. In this example, the controller 1b selects the section that is located between nodes N1 and N2 and to which the highest priority has been given. Then, the controller 1b instructs the start node N1 among the nodes N1 and N2 to increase the output power of the signal to be transmitted in the path P1a.

In this case, when the margin of the path P1a becomes positive due to the increase in the signal output power of the node N1, the controller 1b terminates the adjustment of the signal output power. Specifically, when the signal-to-noise ratio of the terminal node N4 of the path P1a exceeds the signal-to-noise ratio limit of the node N4, the controller 1b terminates the adjustment of the signal output power.

On the other hand, if the controller 1b increases the signal output power of the node N1 to an output upper limit, and the margin of the path P1a does not become positive, the signal output power of the node N1 is maintained at the output upper limit.

Then, the controller 1b selects the section that is located between the nodes N2 and N3 and to which the second highest priority has been given. Then, the controller 1b instructs the start node N2 among the nodes N2 and N3 to increase the output power of the signal to be transmitted in the path P1a. In this manner, the controller 1b sequentially adjusts the signal output power until the margin of the path 1a becomes positive.

In S4, when the controller 1b terminates the adjustment of the signal output power for the path P1a, the controller 1b detects a path having a positive margin and extending between nodes of the path P1a. Then, the controller 1b reduces and adjusts the signal output power in such a manner that a margin of the detected path does not become negative and that the signal output power does not become lower than a lower limit. In this case, the controller 1b reduces and adjusts the signal output power for a path including the section that is located between the nodes and to which the highest priority has been given in S3.

In this example, the section to which the highest priority has been given is located between the nodes N1 and N2, and the path P1b extends through the section located between the nodes N1 and N2. The path P1b has the positive margin. Thus, the controller 1b instructs the node N1 to reduce and adjust the output power of the signal to be transmitted in the path P1b.

A node instructed by the network control apparatus 1 to adjust signal output power adjusts the signal output power by controlling an amplifier included in the node and configured to amplify a signal level, a variable attenuator (VAT) included in the node and configured to attenuate the signal level in a variable manner, or the like.

In this manner, the network control apparatus 1 determines, based on signal qualities between the nodes on the routes of the paths, a node of which signal output power is to be adjusted in the design of the network. Then, the network control apparatus 1 instructs the determined node to adjust the signal output power. Thus, the network cost may be suppressed.

The network control apparatus 1 reduces and adjusts the signal output power for a path having a positive margin in such a manner that the margin does not become negative and that the signal output power does not become lower than the lower limit. Thus, the signal output power is not set to a value equal to or higher than a predetermined value, and resources may be efficiently used. In addition, it may be possible to suppress the degradation, caused by excessively high signal output power, of transmission characteristics.

### Second Embodiment

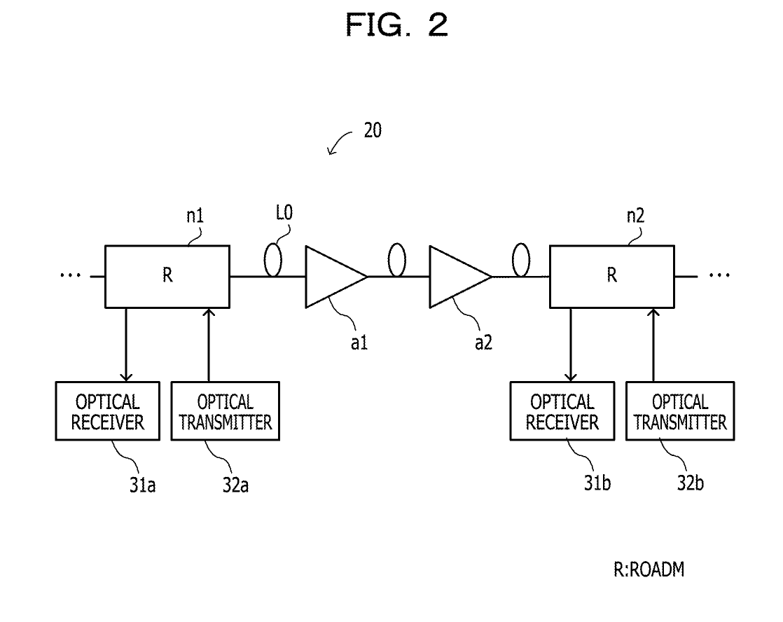

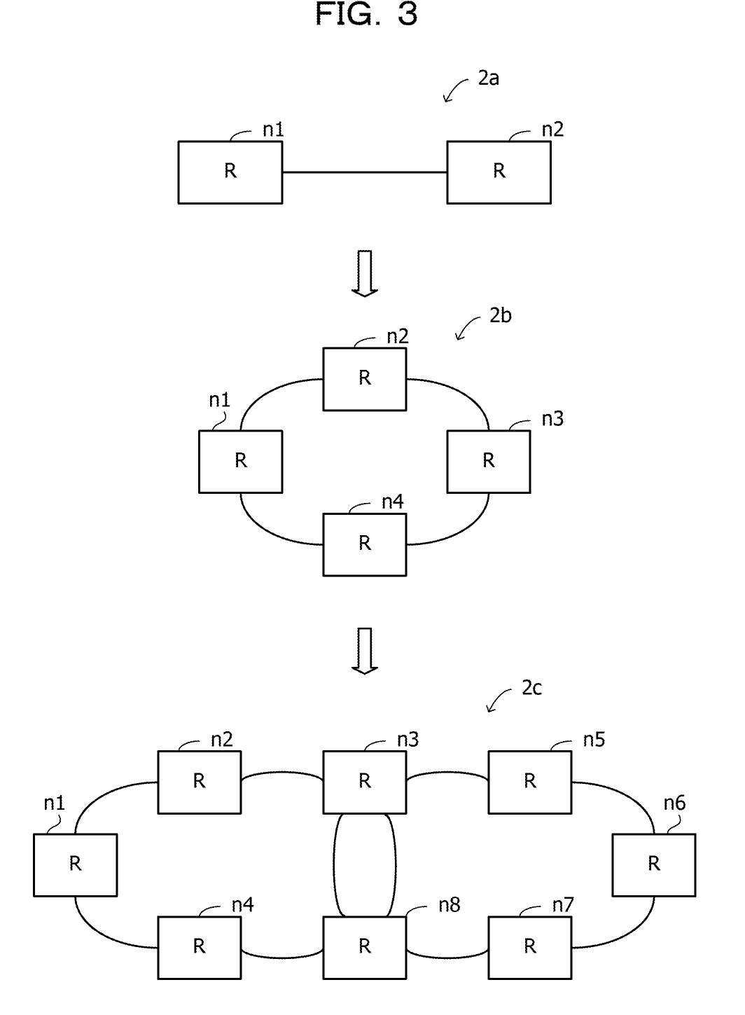

Next, a second embodiment is described. A network control apparatus according to the second embodiment determines, based on OSNRs of optical paths extending through sections between nodes in an optical network in which WDM optical transmission is executed, nodes of which optical output power is adjusted. The network control apparatus according to the second embodiment notifies the determined nodes of the adjustment of the optical output power. First, an example of the configuration of the optical network in which the WDM optical transmission is executed and examples of the expansion of the topology of the optical network are described with reference to FIGS. 2 and 3.

FIG. 2 is a diagram illustrating the example of the configuration of the optical network. An optical network 20 is a multi-relay network in which WDM transmission is executed. The optical network 20 includes nodes n1 and n2 and inline amplifiers (ILAs) a1 and a2.

At relay points between the nodes n1 and n2, the inline amplifiers a1 and a2 that are liner optical relay devices are installed. The nodes n1 and n2 and the inline amplifiers a1 and a2 are connected to each other via an optical fiber L0 in a linear manner (and the number of inline amplifiers is arbitrary). An optical receiver 31a and an optical transmitter 32a are connected to the node n1. An optical receiver 31b and an optical transmitter 32b are connected to the node n2.

In the nodes n1 and n2, reconfigurable optical add and drop multiplexing (ROADM) control is executed to add light with an arbitrary wavelength and drop light with an arbitrary wavelength.

Specifically, upon receiving a wavelength channel transmitted by the optical transmitter 32a, the node n1 adds the wavelength channel to WDM signal light having passed through the optical fiber L0 and multiplexes and outputs the WDM signal light having the wavelength channel to the node n2 located at the next stage.

The node n1 receives the WDM signal light having passed through the optical fiber L0, separates the wavelength of the WDM signal light to drop a predetermined wavelength channel, and transmits the WDM signal light to the optical receiver 31a. In the node n2, the same ROADM control is executed.

FIG. 3 is a diagram illustrating the examples of the expansion of the topology of the optical network. An optical network 2a includes the nodes n1 and n2. The optical network 2a has a linear configuration in which the nodes n1 and n2 are connected to each other in a point-to-point manner.

An optical network 2b includes nodes n1, . . . , and n4 and has a ring configuration in which the nodes n1 . . . , and n4 are connected to each other in a loop form.

An optical network 2c includes node n1, . . . , and n8, while the nodes n3 and n8 have a hub line concentration function and connect two ring networks to each other. The optical network 2c has a hub and mesh configuration in which the nodes n1 . . . , and n8 are connected to each other in a mesh form.

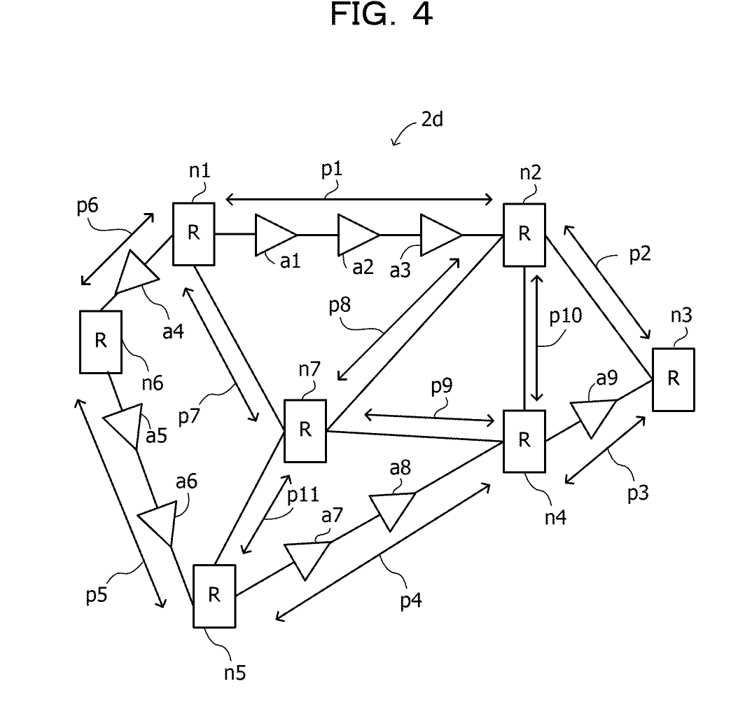

Next, optical paths established between nodes in an optical network are described. FIG. 4 is a diagram illustrating an example of the establishment of the optical paths in the optical network. An optical network 2d includes nodes n1, . . . , and n7 and inline amplifiers a1, . . . , and a9. In the optical network 2d, 11 optical paths p1, . . . , and p11 are established.

The optical path p1 is established between the nodes n1 and n2. The optical path p2 is established between the nodes n2 and n3. The optical path p3 is established between the nodes n3 and n4. The optical path p4 is established between the nodes n4 and n5. The optical path p5 is established between the nodes n5 and n6. The optical path p6 is established between the nodes n1 and n6.

The optical path p7 is established between the nodes n1 and n7. The optical path p8 is established between the nodes n2 and n7. The optical path p9 is established between the nodes n4 and n7. The optical path p10 is established between the nodes n2 and n4. The optical path p11 is established between the nodes n5 and n7.

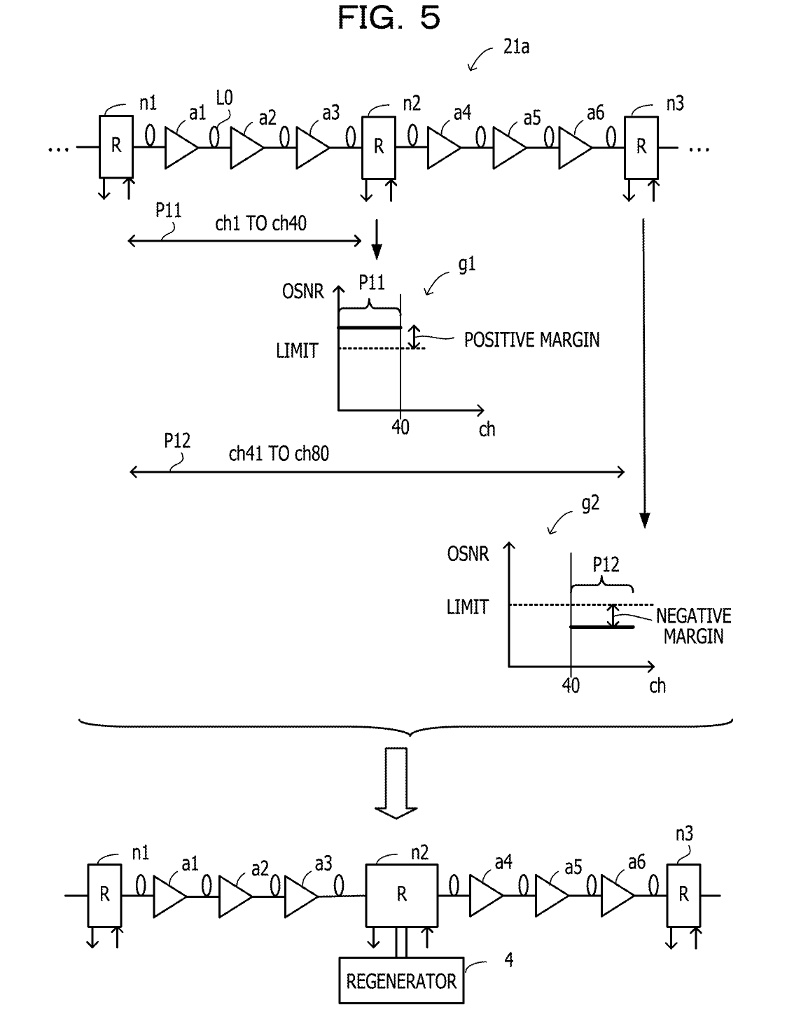

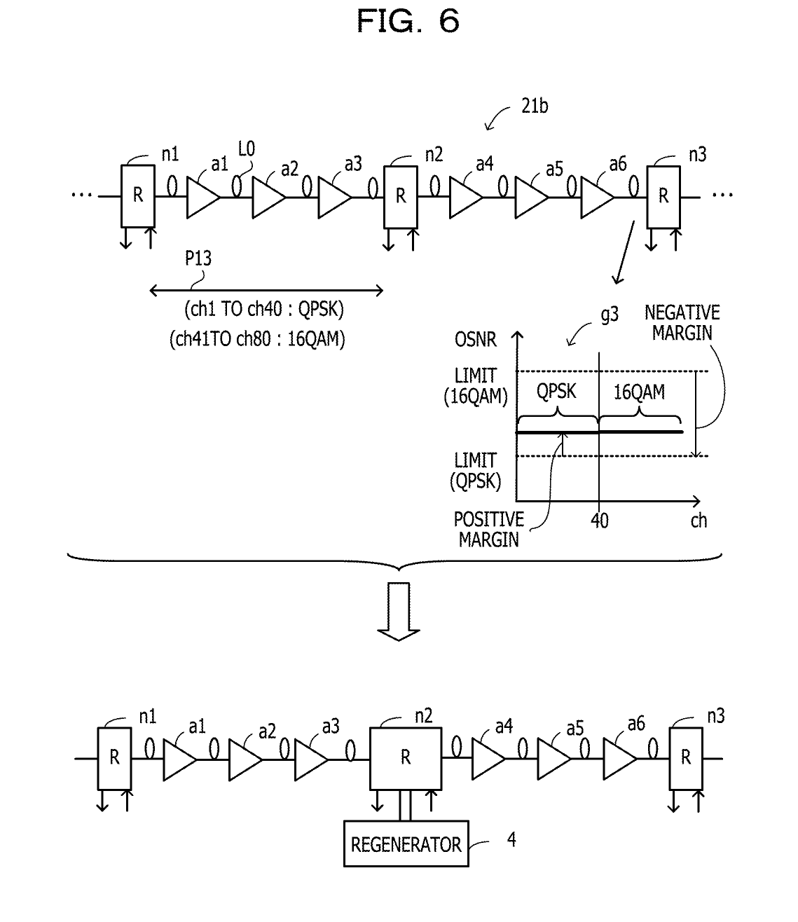

Next, a state in which a regenerator is installed in a node included in an optical network is described with reference to FIGS. 5 and 6. The regenerator (REG) converts received signal light to an electric signal, executes processes including waveform shaping and amplification on the electric signal, reconverts the electric signal after the processes to signal light, and outputs the signal light. In the following description, an illustration of optical transmitters connected to the nodes and optical receivers connected to the nodes is omitted.

FIG. 5 is a diagram describing an example of the state in which the regenerator is installed. In each of graphs g1 and g2, an abscissa indicates a wavelength channel ch, and an ordinate indicates an OSNR. An optical network 21a includes nodes n1, n2, and n3 and inline amplifiers a1, . . . , and a6 and executes WDM transmission that enables the wavelength multiplexing of 80 waves.

The inline amplifiers a1, a2, and a3 are installed between the nodes n1 and n2. The inline amplifiers a4, a5, and a6 are installed between the nodes n2 and n3. The nodes n1, n2, and n3 and the inline amplifiers a4, a5, and a6 are connected to the optical fiber L0 in a linear manner.

In the optical path P11 established between the nodes n1 and n2, wavelength channels ch1 to ch40 are used for short-distance transmission. In the optical path P12 established between the nodes n1 and n3, wavelength channels ch41 to ch80 are used for long-distance transmission.

It is assumed that optical output power of all the nodes is set in such a manner that OSNRs of the optical paths included in the optical network 21a are equal to each other. In this case, it is likely that, in the optical path P11 in which the wavelength channels ch1 to ch40 are used for short-distance transmission, OSNRs become higher than an OSNR limit of an optical receiving section included in the node n2 (or the optical path P11 has a positive margin with respect to the OSNR limit), as indicated in the graph g1.

There is, however, a possibility that, in the optical path P12 in which the wavelength channels ch41 to ch80 are used for long-distance transmission, the OSNRs become lower than an OSNR limit of an optical receiving section included in the node n3 (or the optical path P12 has a negative margin with respect to the OSNR limit), as indicated in the graph g1.

This is due to the fact that, in the case where the optical output power is set in such a manner that the OSNRs are equal to each other and the wavelength channels ch41 to ch80 are used, optical output power for long-distance transmission from the node n1 through the node n2 to the node n3 is insufficient.

In order to normally transmit the wavelength channels ch41 to ch80, a regenerator 4 may be installed in the node n2 and suppress reductions in the OSNRs by executing regenerative relay on the wavelength channels ch41 to ch80, for example.

FIG. 6 is a diagram describing an example of the state in which the regenerator is installed. The configuration of an optical network 21b is the same as that of the optical network 21a illustrated in FIG. 5. In the optical network 21b, WDM transmission is executed to transmit the wavelength channels ch1 to ch80.

In the optical network 21b, an optical path P13 is established between the nodes n1 and n2. In the optical path P13, quadrature phase shift keying (QPSK) of 100 Gb/s throughput is used for the modulation of the wavelength channels ch1 to ch40 for short wavelengths.

16 quadrature amplitude modulation (QAM) of 200 Gb/s throughput is used for the modulation of the wavelength channels ch41 to ch80 for long wavelengths.

It is assumed that optical output power of all the nodes established in the optical network 21b is set in such a manner that OSNRs of the optical path established in the optical network 21b are equal to each other for all the modulation. In this case, since the wavelength channels ch1 to ch40 for QPSK is used for short-distance transmission, it is likely that the OSNRs are higher than the OSNR limit of the optical receiving section included in the node n2 for QPSK, as indicated in the graph g3.

However, even if the wavelength channels ch41 to ch80 for 16 QAM are used for short-distance transmission, the OSNRs may become lower than the OSNR limit of the optical receiving section included in the node n3 for 16 QAM.

While the amount of information to be transmitted per unit of time in 16 QAM is larger than that in QPSK, an error rate of 16 QAM is larger than that of QPSK. Thus, in order to obtain the same error rate as that of QPSK, the OSNRs of the receiving node are to be increased by setting output levels in 16 QAM to be higher than those in QPSK. Thus, the OSNR limit in 16 QAM is higher than the OSNR limit in QPSK.

Thus, in the case where the optical output power is set in such a manner that the OSNRs are equal to each other and the wavelength channels ch41 to ch80 are used, the OSNRs may become lower than the OSNR limit of the optical receiving section included in the node n2 for 16 QAM.

Thus, in order to normally transmit the wavelength channels ch41 to ch80, the regenerator 4 may be installed in the node n2 in the same manner as the case illustrated in FIG. 5 and suppress reductions in the OSNRs by executing the regenerative relay on the wavelength channels ch41 to ch80. This suppresses reductions in the OSNRs.

In the optical networks 21a and 21b, the optical paths of which transmission distances are different from each other exist or different types (100-Gb/s QPSK, 200-Gb/s 16 QAM, 300-Gb/s 64 QAM, and the like) of the signal modulation are used. Thus, in the case where the optical output power is set in such a manner that the OSNRs are equal to each other, an optical path that does not satisfy an OSNR limit may exist.

However, if the regenerator is installed in the node located on the aforementioned optical path to satisfy the OSNR limit, the number of nodes in which regenerators are to be installed may increase due to the expansion of an optical network topology or the like, and the network cost may increase.

Under such circumstances, according to the network control apparatus according to the second embodiment, a regenerator is not installed and the network cost is suppressed by the adjustment of optical output power for a wavelength channel that does not satisfy an OSNR limit. The network control apparatus according to the second embodiment adjusts the optical output power in such a manner that, even if OSNR limits are satisfied, output levels are not increased to a predetermined level or higher. The configuration and operations of the network control apparatus according to the second embodiment are described below in detail.

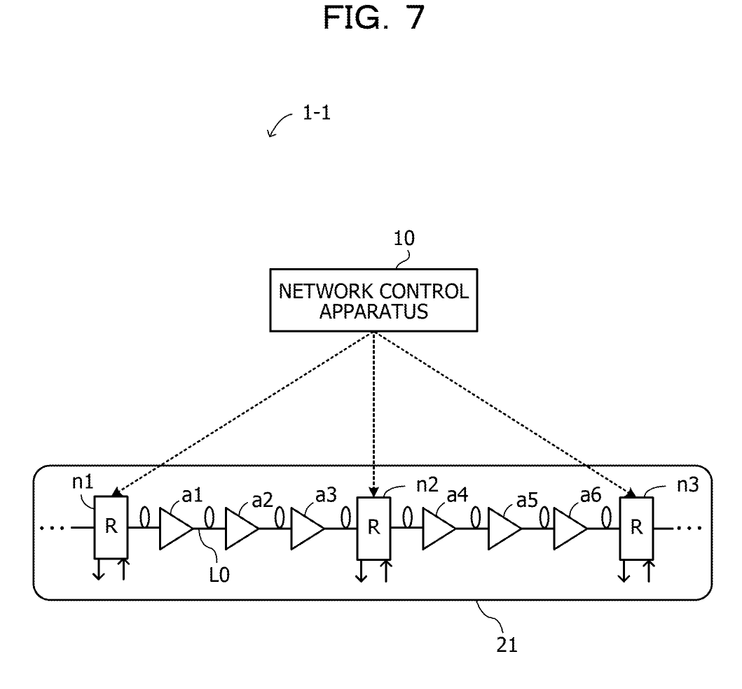

The configuration of a network control system in which the network control apparatus is connected to an optical network is described below. FIG. 7 is a diagram illustrating an example of the configuration of the network control system. A network control system 1-1 includes an optical network 21 and a network control apparatus 10.

The optical network 21 includes nodes n1, n2, and n3 and inline amplifiers a1, . . . , and a6. The inline amplifiers a1, a2, and a3 are installed between the nodes n1 and n2. The inline amplifiers a4, a5, and a6 are installed between the nodes n2 and n3. The nodes n1, n2, and n3 and the inline amplifiers a1, . . . , and a6 are connected to each other via the optical fiber L0 in a linear manner.

The network control apparatus 10 is connected to one or multiple nodes within the optical network 21. The network control apparatus 10 transmits an instruction to adjust optical output power to a predetermined node within the optical network 21. Then, the predetermined node adjusts the optical output power based on the received instruction to adjust the optical output power.

FIG. 7 illustrates the example in which the network control apparatus 10 is connected to the optical network 21 having a linear configuration. The network control apparatus 10, however, may be connected to an optical network that has a ring configuration, a mesh configuration, or the like or has one or more of various topologies.

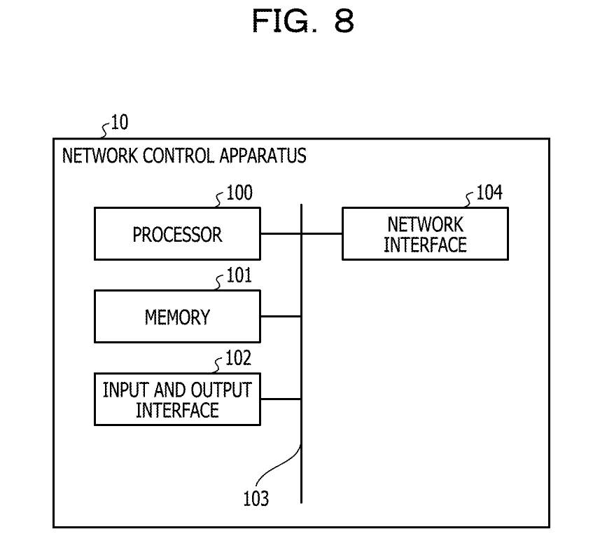

Next, a hardware configuration of the network control apparatus 10 is described. FIG. 8 is a diagram illustrating an example of the hardware configuration of the network control apparatus. The entire network control apparatus 10 is controlled by a processor 100. The processor 100 functions as a controller of the network control apparatus 10.

The processor 100 is connected to a memory 101 and multiple peripheral devices via a bus 103. The processor 100 may be a multiprocessor. The processor 100 is, for example, a central processing unit (CPU), a micro processing unit (MPU), a digital signal processor (DSP), an application specific integrated circuit (ASIC), or a programmable logic device (PLD). Alternatively, the processor 100 may be a combination of two or more of a CPU, an MPU, a DSP, an ASIC, and a PLD.

The memory 101 is used as a main storage device of the network control apparatus 10. In the memory 101, a portion of a program of an operating system (OS) to be executed by the processor 100 and an application program is temporarily stored, or the program of the OS and the application program are temporarily stored. In addition, in the memory 101, various types of data to be used for processes to be executed by the processor 100 are stored.

The memory 101 is used also as an auxiliary storage device of the network control apparatus 10. In the memory 101, the program of the OS, the application program, and the various types of data are stored. In the case where the memory 101 is used as the auxiliary storage device, the memory 101 may include a magnetic recording medium that is a semiconductor storage device such as a flash memory or an SSD, an HDD, or the like.

The peripheral devices connected to the bus 103 are an input and output interface 102 and a network interface 104. The input and output interface 102 is connected to a monitor (for example, a light emitting diode (LED), a liquid crystal display (LCD), or the like) that functions as a display device that displays the state of the storage control apparatus 10 in accordance with a command from the processor 100.

In addition, the input and output interface 102 may be connected to an information input device such as a keyboard or a mouse and transmits a signal transmitted by the information input device to the processor 100.

Furthermore, the input and output interface 102 functions as a communication interface that connects the peripheral devices to each other. For example, the input and output interface 102 may be connected to an optical driving device that uses laser light or the like to read data recorded in an optical disc. The optical disc is a portable recording medium in which the data that is read by light reflection is recorded. Examples of the optical disc are a digital versatile disc, (DVD), a DVD random access memory (DVD-RAM), a compact disc read only memory (CD-ROM), a CD-Recordable (CD-R), and a CD-Rewritable (CD-RW).

The input and output interface 102 may be connected to a memory device or a memory reader or writer. The memory device is a recording medium that has a communication function of executing communication with the input and output interface 102. The memory reader or writer is a device that writes a message to a memory card or reads a message from the memory card. The memory card is a card-type recording medium.

The network interface 104 may be a network interface card (NIC), a radio local area network (LAN), or the like, for example. A signal, data, and the like that are received by the network interface 104 are output to the processor 100.

Processing functions of the network control apparatus 10 are achieved by the aforementioned hardware configuration. For example, the network control apparatus 10 controls and adjusts optical output power by causing the processor 100 to execute predetermined programs.

The network control apparatus 10 executes a program recorded in a computer-readable recording medium, thereby achieving the processing functions according to the second embodiment, for example. The program in which details of processing to be executed by the network control apparatus 10 are described may be recorded in various recording media.

For example, the program to be executed by the network control apparatus 10 may be stored in the auxiliary storage device. The processor 100 loads a portion of the program stored in the auxiliary storage device or the entire program into the main storage device and executes the loaded program. The program may be recorded in a portable recording medium such as an optical disc, a memory device, or a memory card. For example, the program stored in the portable recording medium may be installed in the auxiliary storage device and executed under control by the processor 100. The processor 100 may read the program directly from the portable recording medium and execute the read program.

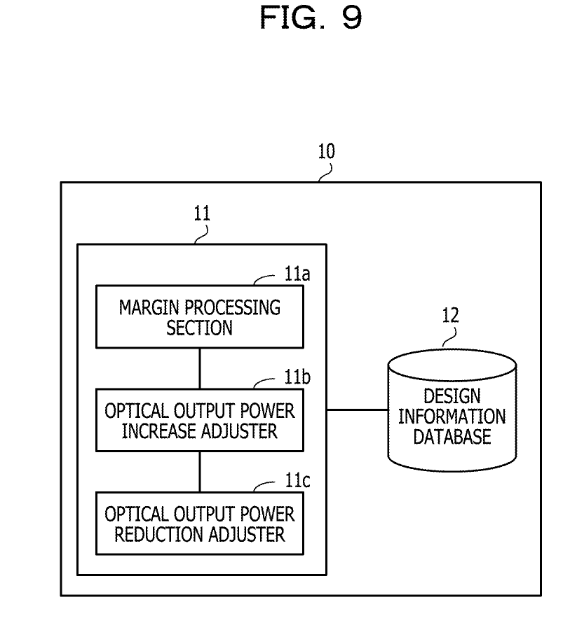

Next, functional blocks of the network control apparatus 10 are described. FIG. 9 is a diagram illustrating an example of the functional blocks of the network control apparatus. The network control apparatus 10 includes a network controller 11 and a design information database 12.

The network controller 11 includes a margin processing section 11a, an optical output power increase adjuster 11b, and an optical output power reduction adjuster 11c. The network controller 11 achieves the functions of the controller 1b illustrated in FIG. 1, while the design information database 12 achieves the functions of the storage section 1a illustrated in FIG. 1.

The margin processing section 11a calculates margins of optical paths included in an optical network and gives priorities to sections between nodes of the optical network based on values of the margins. The optical output power 11b instructs a node, which is to be adjusted, to increase and adjust optical output power for a path having a negative margin.

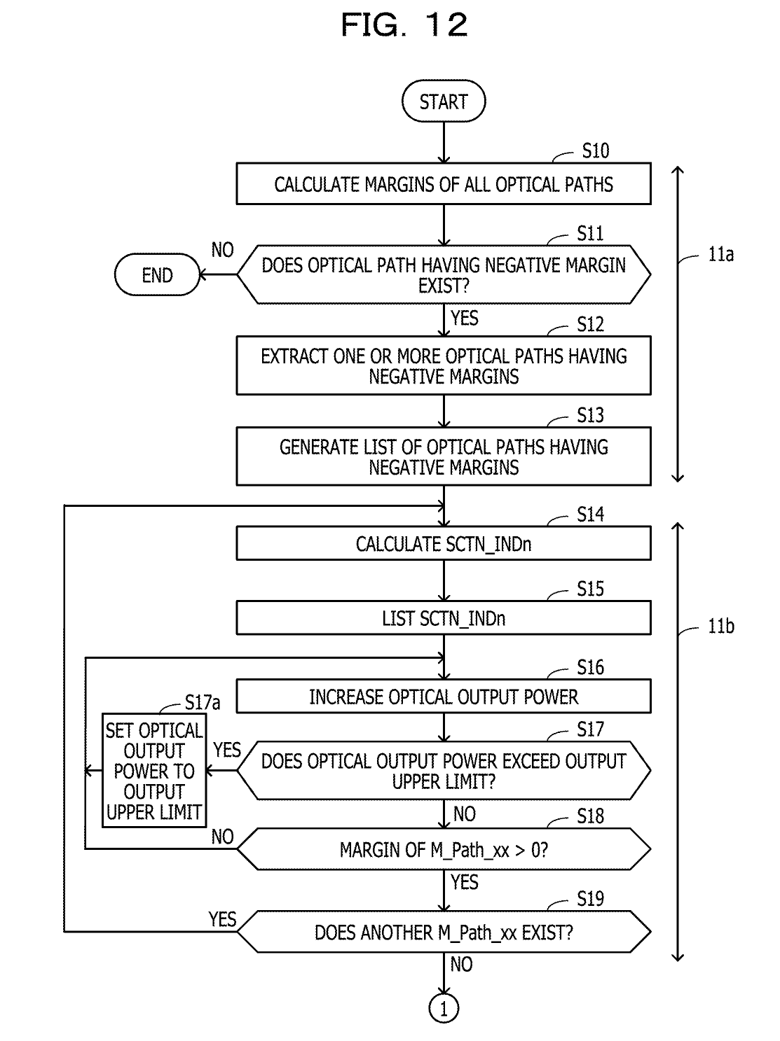

The optical output power reduction adjuster 11c instructs a node, which is to be adjusted, to reduce and adjust optical output power for a path having a positive margin and extending through a portion of the path having the negative margin. The optical output power is adjusted or controlled upon the design of the optical network or upon a change in the topology of the optical network. Detailed operations of the network controller 11 are described later with reference to FIG. 12 and later.

In the design information database 12, design information (for example, information to be used to calculate and manage signal qualities of the optical paths) to be used for the design of the optical network is stored. Parameters of the design information include, for example, losses in the transmission paths, the distances of the transmission paths, the types of the transmission paths, input power for the transmission paths, noise figures (NFs) of optical amplifiers, gains of the optical amplifiers, gain tilts of the optical amplifiers, and nonlinear penalties.

In addition, the parameters of the design information include polarization mode dispersion (PMD) and polarization dependent loss (PDL) penalties, OSNR tolerance of optical receivers, and the like. These parameters may be manually calculated or may be monitor values obtained by monitoring the optical network. Various types of table information described later are stored in the design information database 12.

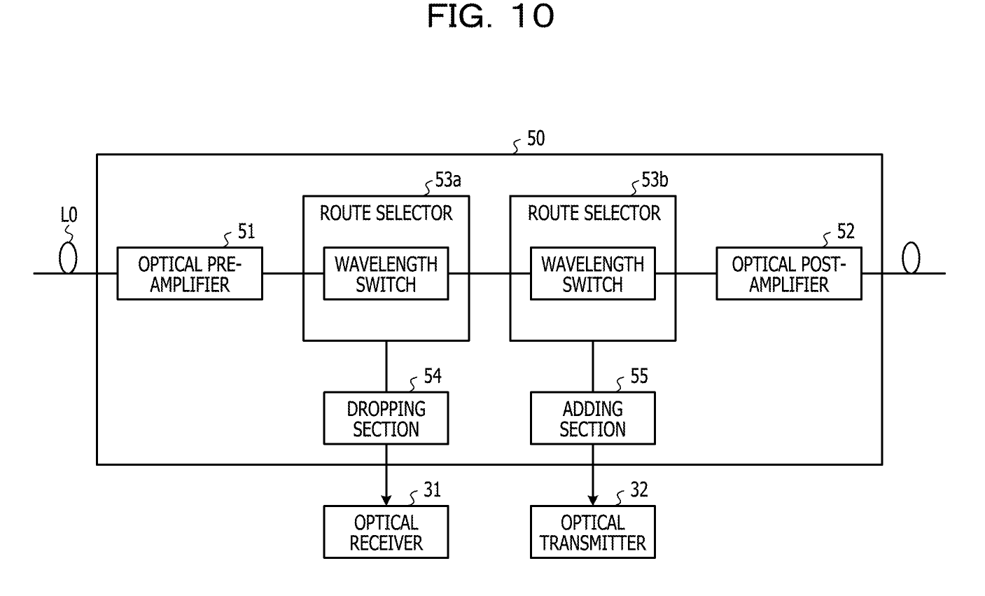

Next, a configuration of each of nodes forming the optical network is described. FIG. 10 is a diagram illustrating an example of a configuration of a node. A node 50 includes an optical pre-amplifier 51, an optical post-amplifier 52, route selectors 53a and 53b, a dropping section 54, and an adding section 55 (or a configuration per path is illustrated). The node 50 is connected to an optical receiver 31 and an optical transmitter 32.

The optical pre-amplifier 51 receives WDM signal light having passed through the optical fiber L0 and amplifies the WDM signal light. The route selector 53a includes a wavelength switch sa-1, while the route selector 53b includes a wavelength switch sb-1. As the wavelength switches, wavelength selective switches (WSSs) are used, for example.

The route selector 53a separates the wavelength of the received WDM signal light and selects a wavelength channel. The route selector 53b receives the wavelength channel output from the route selector 53a and executes wavelength multiplexing on the wavelength channel. The optical post-amplifier 52 amplifies light output from the route selector 53b and outputs the amplified light from the optical fiber L0.

The dropping section 54 receives the wavelength channel output from the route selector 53a and transmits a predetermined wavelength channel to the optical receiver 31. The adding section 55 multiplexes wavelength channels transmitted by the optical transmitter 32 and transmits the multiplexed wavelength channels to the route selector 53b.

Although not illustrated, a variable optical attenuator (VOA) is installed between the route selector 53a and the route selector 53b for each of the wavelength channels, for example. Upon receiving an instruction to adjust optical output power from the network control apparatus 10, the node 50 variably controls output of the VOA included in the node 50, thereby adjusting the optical output power for each of the wavelength channels. Alternatively, the node 50 may use VOA functions included in the WSSs to variably control the output of the VOA included in the node 50 and adjust the optical output power for each of the wavelength channels.

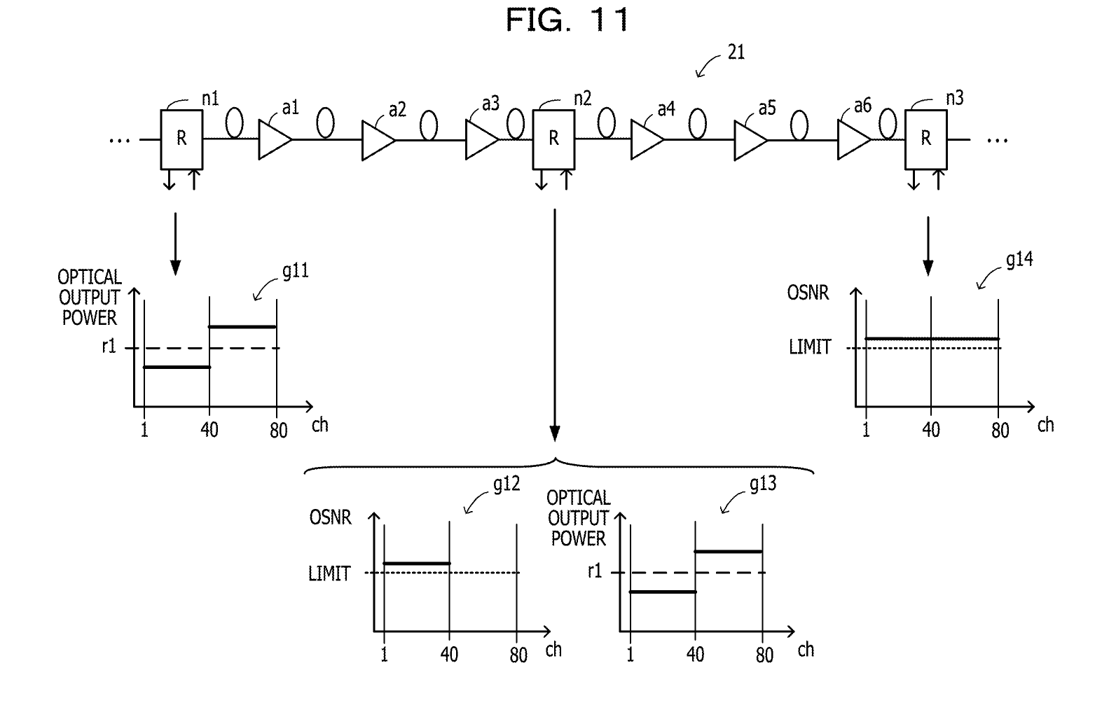

FIG. 11 is a diagram illustrating an example of the adjustment of the optical output power. FIG. 11 illustrates the example in which the optical output power of the nodes n1 and n2 included in the optical network 21 is adjusted by the network control apparatus 10 for each of the wavelength channels.

In each of graphs g11, . . . , and g14, an abscissa indicates a wavelength channel. In each of the graphs g11 and g13, an ordinate indicates optical output power. In each of the graphs g12 and g14, an ordinate indicates an OSNR.

The node n1 transmits WDM signal light including the wavelength channels ch1 to ch80 to the node n2. Upon receiving the WDM signal light transmitted by the node n1, the node n2 drops the wavelength channels ch1 to ch40 to a tributary.

New wavelength channels ch1 to ch40 are added to the node n2 from the tributary. The node n2 multiplexes the added new wavelength channels ch1 to ch40 and the wavelength channels ch41 to ch80 transmitted by the node n1 to transmit the WDM signal light including the wavelength channels ch1 to ch80 to the node n3. Upon receiving the WDM signal light transmitted by the node n2, the node n3 drops the wavelength channels ch1 to ch80 to the tributary.

In this case, the wavelength channels ch1 to ch40 are transmitted between the nodes n1 and n2 or between the nodes n2 and n3 and are wavelength channels for short-distance transmission. The wavelength channels ch41 to ch80 are transmitted between the n1 and n3 via the node n2 and are wavelength channels for long-distance transmission.

In all the nodes forming the optical network, a standard value of optical output power for transmission of WDM signal light including all wavelengths is set. In the example illustrated in FIG. 11, in the nodes n1 and n2 that transmit WDM signal light including all the wavelengths of the wavelength channels ch1 to ch80, a standard value r1 of optical output power is set, as indicated in the graphs g11 and g13.

The standard value r1 is an optical output power value, set in advance upon the design of the optical network, of the WDM signal light including all the wavelength channels and to be wavelength-multiplexed in the optical network.

When the WDM signal light is to be transmitted by the node n1, the node n1 sets optical output power of the wavelength channels ch1 to ch40 in such a manner that OSNRs are higher than an OSNR limit of the optical receiving section included in the node n2 (refer to the graph g12).

In this case, if the wavelength channels ch1 to ch40 are set and transmitted in such a manner that the optical output power is lower than the standard value r1, and the OSNRs are higher than the OSNR limit, the node n1 sets the optical output power of the wavelength channels ch1 to ch40 to be lower than the standard value r1.

Thus, optical amplifier resources for the wavelength channels ch1 to ch40 of which the optical output power is lower by a negative margin than the standard value r1 may be assigned to the transmission of the wavelength channels ch41 to ch80, and the efficiency of assigning the resources may be improved.

When WDM signal light is transmitted at a predetermined output level or higher regardless of short-distance transmission, nonlinear waveform distortion may noticeably occur and result in an increase in the degradation of the quality of the transmission due to a nonlinear effect (cross phase modulation (XPM) or the like) of the optical fiber transmission. Thus, an effect of suppressing the degradation of the quality of transmission may be obtained by transmitting the wavelength channels ch1 to ch40 in such a manner that the optical output power is lower than the standard value r1.

Since the wavelength channels ch41 to ch80 are used for long-distance transmission, the node n1 sets the optical output power of the wavelength channels ch41 to ch80 to be higher than the standard value r1.

Thus, the node n1 sets the optical output power of the wavelength channels ch1 to ch40 to be lower than the standard value r1, sets the optical output power of the wavelength channels ch41 to ch80 to be higher than the standard value r1, and transmits the WDM signal light including the wavelength channels ch1 to ch80, as indicated in the graph g11.

The optical output power of the wavelength channels ch1 to ch40 and the optical output power of the wavelength channels ch41 to ch80 are set by the node n1 based on an instruction, received from the network control apparatus 10, to adjust the optical output power.

The node n2 adjusts the optical output power in the same manner as the node n1 for the transmission of the WDM signal light by the node n2. Specifically, the node n2 sets the optical output power of the wavelength channels ch1 to ch40 added from the tributary to be lower than the standard value r1 and sets the optical output power of the wavelength channels ch41 to ch80 to be higher than the standard value r1, as indicated in the graph g13. Then, the node n2 transmits the WDM signal light including the wavelength channels ch1 to ch80.

The optical output power of the wavelength channels ch1 to ch40 and the optical output power of the wavelength channels ch41 to ch80 are set by the node n2 based on an instruction, received from the network control apparatus 10, to adjust the optical output power.

As described above, since the nodes n1 and n2 set the optical output power of the wavelength channels, the OSNRs of all the wavelength channels ch1 to ch80 that have reached the node 3 are higher than the OSNR limit of the optical receiving section included in the node 3 (refer to the graph g14). Thus, the WDM transmission of all the wavelength channels ch1 to ch80 is executed without a regenerator.

Since the optical transmission is executed in such a manner that the OSNR limit is satisfied due to the adjustment of the optical output power by the network control apparatus 10, a regenerator is not installed in the nodes and the network cost may be suppressed.

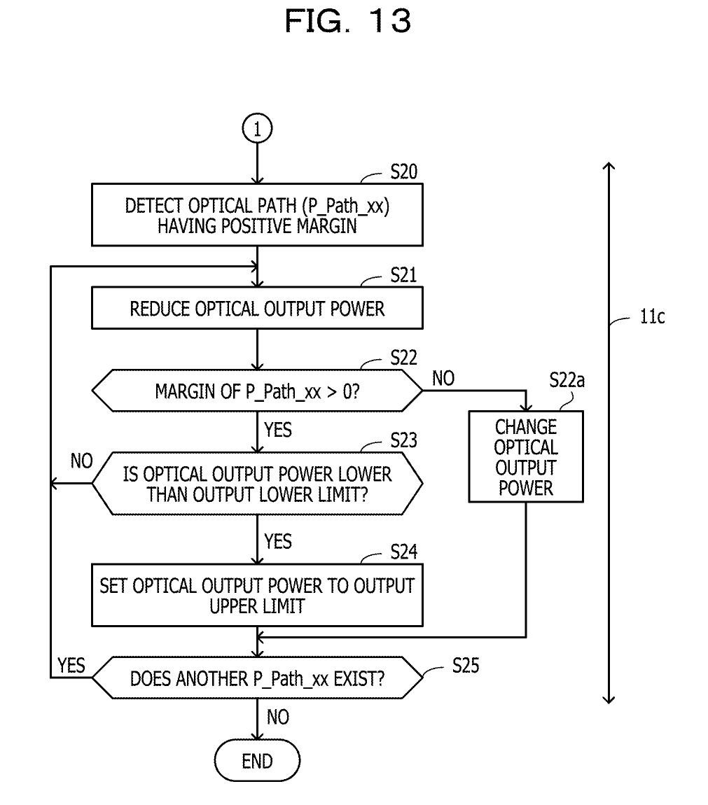

Next, operations of the network control apparatus 10 are described with reference to FIGS. 12 and 13. FIGS. 12 and 13 are flowcharts of an example of the operations of the network control apparatus. S10 to S13 are operations of the margin processing section 11a. S14 to S19 are operations of the optical output power increase adjuster 11b. S20 to S25 are operations of the optical output power reduction adjuster 11c.

In all the nodes forming the optical network, the standard value of the optical output power that is used for the transmission of WDM signal light including all the wavelengths is set. Optical paths are established between predetermined nodes based on the standard value (in a state that is hereinafter referred to as initially designed state). In FIGS. 12 and 13, M_Path_xx indicates a path having a negative margin, and P_Path_xx indicates a path having a positive margin.

In S10, the margin processing section 11a calculates margins of all optical paths established in the optical network in the initially designed state. Specifically, the margin processing section 11a calculates, as the margins, differences between OSNRs of terminal nodes of the optical paths and OSNR limits of the terminal nodes.

In S11, the margin processing section 11a determines whether or not one or more negative margins (margins when OSNRs of one or more optical paths are lower than an OSNR limit) exist among the margins of all the optical paths. If the one or more negative margins do not exist among the margins of all the optical paths, a process is terminated. If the one or more negative margins exist among the margins of all the optical paths, the process proceeds to S12.

In S12, the margin processing section 11a extracts the one or more optical paths having the one or more negative margins.

In S13, the margin processing section 11a gives ranks to the optical paths having the negative margins in descending order of absolute negative margin value and lists the optical paths having the negative margins.

In S14, the optical output power increase adjuster 11b treats the optical paths listed in S13 as optical paths (M_Path_xx) for which optical output power is to be increased. Then, the optical output power increase adjuster 11b calculates OSNRs (OSNRn) of the optical paths and transmitting penalties (TPs) (TPn), calculates section indices (SCTN_INDn) by adding the OSNRs OSNRn to the TPs TPn, and holds the section indices SCTN_INDn. The section indices are used as indices for signal qualities.

In S15, the optical output power increase adjuster 11b gives priorities to the calculated section indices SCTN_INDn in such a manner that, as the value of a calculated section index is smaller, a higher priority is given to the section index, and the optical output power increase adjuster 11b generates a list of the section indices SCTN_INDn.

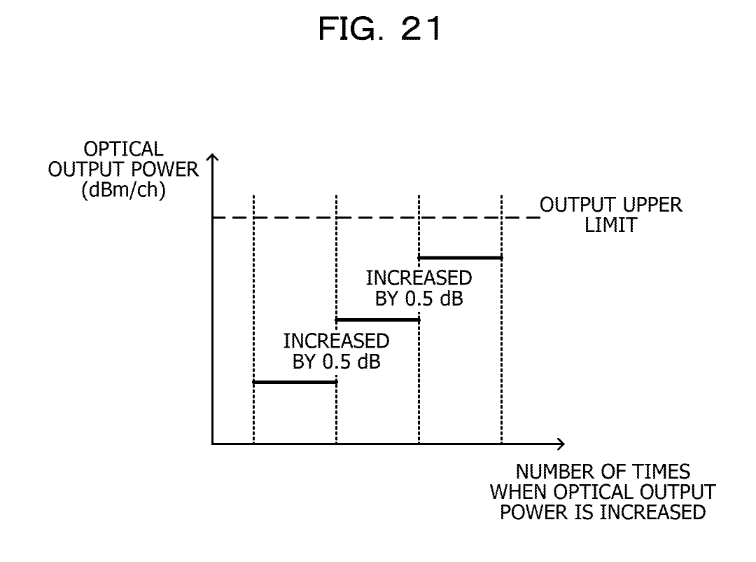

In S16, the optical output power increase adjuster 11b selects a section index SCTN_INDn having the highest priority from among the section indices included in the list generated in S15 and increases optical output power for an optical path (M_Path_xx) having the selected SCTN_INDn d section index. In this case, for example, the optical output power increase adjuster 11b increases the optical output power by a predetermined amount in a stepwise manner (refer to FIG. 21 described later).

In S17, the optical output power increase adjuster 11b determines whether or not the optical output power exceeds the output upper limit. If the optical output power exceeds the output upper limit, the process proceeds to S17a. If the optical output power does not exceed the output upper limit, the process proceeds to S18.

In S17a, the optical output power increase adjuster 11b sets the optical output power for the optical path having the section index SCTN_INDn to the output upper limit. Then, the optical output power increase adjuster 11b selects an optical path having a section index SCTN_IND(n+1) having the next highest priority, causes the process to return to S16, and increases and adjusts optical output power for the selected optical path.

In S18, the optical output power increase adjuster 11b determines whether or not the margin of the optical path (M_Path_xx) is positive. If the margin of the optical path (M_Path_xx) is not positive, the process returns to S16. If the margin of the optical path (M_Path_xx) is positive, the process proceeds to S19.

In S19, the optical output power increase adjuster 11b determines whether or not another optical path having a negative margin exists. If the optical hath having the negative margin exists, the process returns to S14. If the optical hath having the negative margin does not exist, the process proceeds to S20.

In S20, the optical output power reduction adjuster 11c detects an optical path having a positive margin (margin when an OSNR of the optical path is higher than an OSNR limit) and established between nodes through which the optical path (M_Path_xx) for which the optical output power has been increased extends.

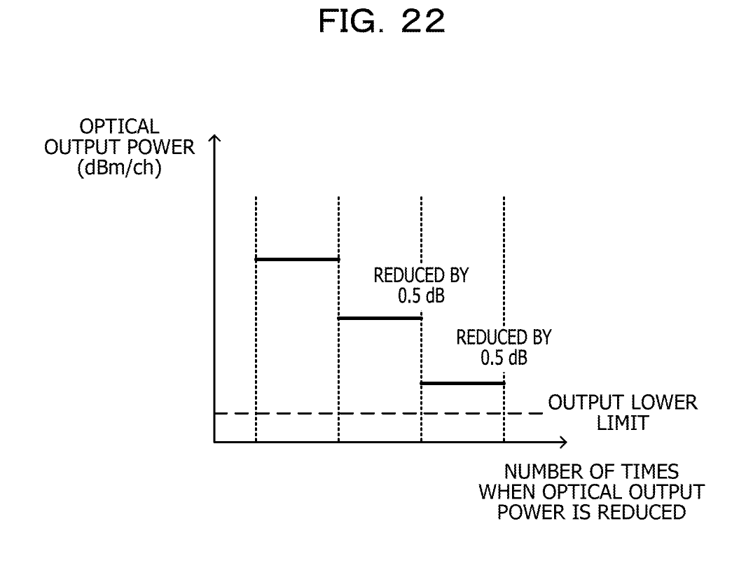

In S21, the optical output power reduction adjuster 11c reduces the optical output power for the optical path (P_Path_xx). In this case, for example, the optical output power reduction adjuster 11c reduces the optical output power by a predetermined amount in a stepwise manner (refer to FIG. 22 described later).

In S22, the optical output power reduction adjuster 11c determines whether or not the margin of the optical path (P_Path_xx) is positive. If the margin of the optical path (P_Path_xx) is not positive, the process proceeds to S22a. If the margin of the optical path (P_Path_xx) is positive, the process proceeds to S23.

In S22a, the optical output power reduction adjuster 11c detects that the optical output power for the optical path (P_Path_xx) has been excessively reduced, and the optical output power reduction adjuster 11c changes the optical output power by restoring the optical output power to a value before the reduction in the optical output power by the predetermined amount until the margin becomes positive again. Then, the process proceeds to S25.

In S23, the optical output power reduction adjuster 11c determines whether or not the optical output power is lower than the output lower limit. If the optical output power is lower than the output lower limit, the process proceeds to S24. If the optical output power is not lower than the output lower limit, the process returns to S21.

In S24, the optical output power reduction adjuster 11c sets the optical output power for the optical path (P_Path_xx) to the output lower limit.

In S25, the optical output power reduction adjuster 11c determines whether or not another optical path (P_Path_xx) exists. If the other optical path (P_Path_xx) exists, the process returns to S21. If the other optical path (P_Path_xx) does not exist, the process is terminated.

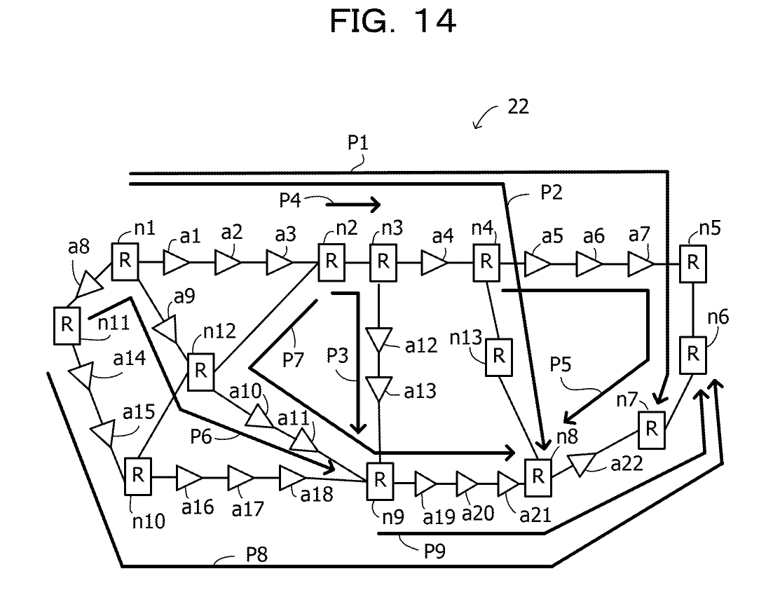

Next, a specific example of the adjustment of the optical output power is described with reference to FIGS. 14 to 20. FIG. 14 is a diagram illustrating an example of the configuration of an optical network. An optical network 22 includes nodes n1, . . . , and n13 and inline amplifiers a1, . . . , and a22. In the optical network 22, 9 optical paths P1 to P9 are established.

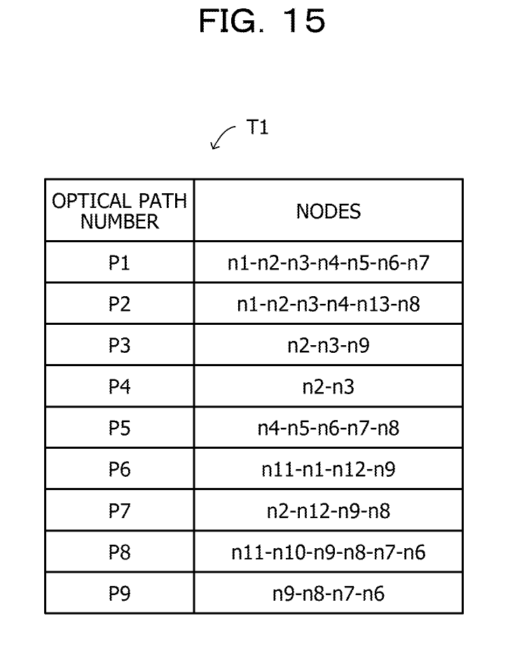

FIG. 15 is a diagram illustrating an example of a route table. A route table T1 includes an optical path number item and a nodes item indicating nodes on the optical paths. In this example, the nodes of the optical paths P1, . . . , and P9 of the optical network 22 illustrated in FIG. 22 are registered.

For example, as nodes of the optical path P1, the nodes n1, n2, n3, n4, n5, n6, and n7 are registered. The route table T1 is stored in the design information database 12.

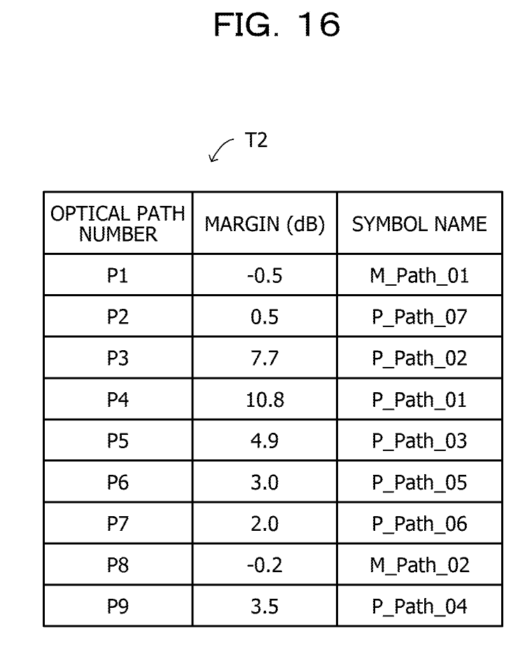

FIG. 16 is a diagram illustrating an example of a margin management table. A margin management table T2 includes an optical path number item, a margin (dB) item, and a symbol name item and is generated by the margin processing section 11a. In the symbol name item, M_Path_xx indicates an optical path having a negative margin, and P_Path_xx indicates an optical path having a positive margin. The margin management table T2 is stored in the design information database 12.

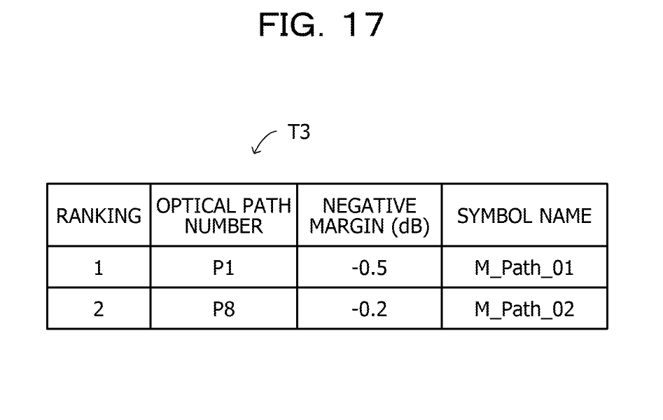

FIG. 17 is a diagram illustrating an example of a negative margin extraction table. A negative margin extraction table T3 includes a ranking item, an optical path number item, a negative margin (dB) item, and a symbol name item.

The margin processing section 11a generates the negative margin extraction table T3 by extracting optical paths having negative margins from the margin management table T2.

As indicated in the margin management table T2 illustrated in FIG. 16, the optical paths P1 and P8 have negative margins. The negative margin of the optical path P1 is −0.5 dB, while the negative margin of the optical path P8 is −0.2 dB. The absolute value of the negative margin of the optical path P1 is larger than the absolute value of the negative margin of the optical path P8.

Thus, the negative margin extraction table T3 is generated in such a manner that the optical path P1 is ranked higher than the optical path P8 (or the optical output power for the optical path P1 is adjusted earlier than the adjustment of the optical output power for the optical path P8), as illustrated in FIG. 17. The negative margin extraction table T3 is stored in the design information database 12.

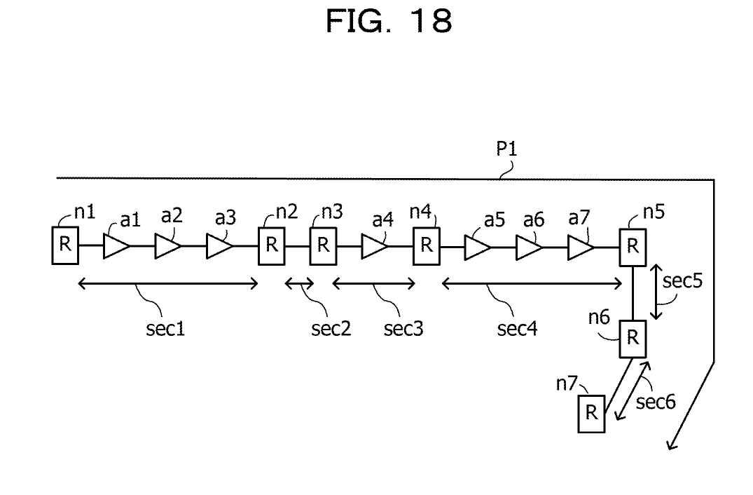

FIG. 18 is a diagram illustrating an example of sections of the optical network. FIG. 18 illustrates the route of the optical path P1 having the negative margin whose absolute value is the maximum among the optical paths included in the optical network 22. The optical path P1 includes the sections sec1, . . . , and sec6.

The section sec1 exists between the nodes n1 and n2. The section sec2 exists between the nodes n2 and n3. The section sec3 exists between the nodes n3 and n4. The section sec4 exists between the nodes n4 and n5. The section sec5 exists between the nodes n5 and n6. The section sec6 exists between the nodes n6 and n7.

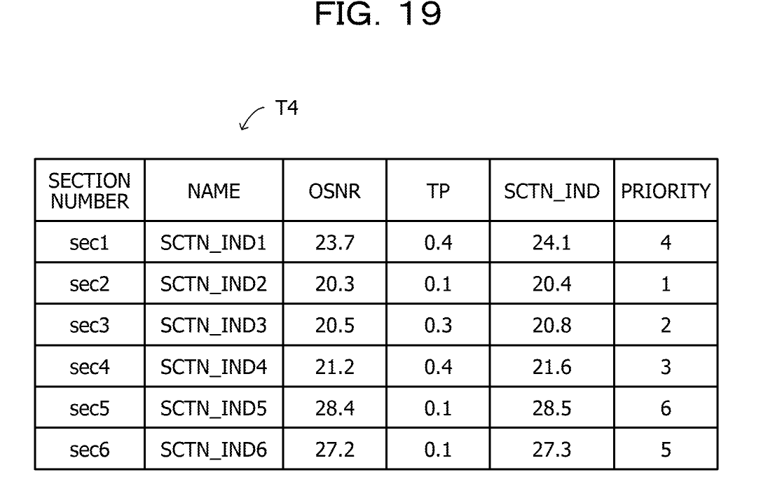

FIG. 19 is a diagram illustrating an example of a section index management table. A section index management table T4 includes a section number item, a name item, an OSNR item, a TP item, an SCTN_IND item (indicating values of section indices), and a priority item and is generated by the optical output power increase adjuster 11b.

For example, regarding the section between the nodes n1 and n2, a section number is sec1, a name is SCTN_IND1, an OSNR is 24.1 (=23.7+0.4), a TP is 0.4, and a priority is 4 (that is the fourth smallest value among 6 section indices SCTN_IND and indicates that optical output power is the fourth to be increased and adjusted). The section index management table T4 is stored in the design information database 12.

The optical output power increase adjuster 11b increases and adjusts optical output power in order from the smallest value among the section indices SCTN_IND registered in the section index management table T4 (or in order from the highest priority).

In this example, the section sec2 has the highest priority, or the priority of the section sec2 is 1. Thus, the optical output power increase adjuster 11b increases and adjusts optical output power of the start node n2 of the section sec2 and terminates the adjustment of the increase in the optical output power when the margin of the optical P1 becomes positive in this adjustment.

If the optical output power reaches the output upper limit, and the margin does not become positive, the optical output power increase adjuster 11b sets the optical output power of the node n2 to the output upper limit and increases and adjusts the optical output power for the section sec3 having the second highest priority. Specifically, since the start node of the section sec3 is the node n3, the optical output power increase adjuster 11b increases and adjusts the optical output power of the node n3.

In this manner, the optical output power increase adjuster 11b sequentially increases and adjusts optical output power based on the priorities until the margin becomes positive. In this example, when the adjustment of the increase in the optical output power of the optical path P1 is completed, the optical output power for the optical path P8 is increased and adjusted in the same manner as described above.

Next, the optical output power reduction adjuster 11c detects a path having a positive margin and including a section located between nodes and having the highest priority (and the smallest section index).

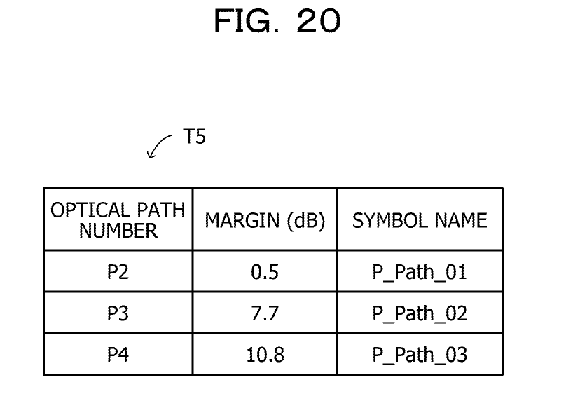

FIG. 20 is a diagram illustrating an example of a reduction target path management table. In a reduction target path management table T5, optical paths for which optical output power is to be reduced and adjusted by the optical output power reduction adjuster 11c are registered. The reduction target path management table T5 includes an optical path number item, a margin (dB) item, and a symbol name item.

The reduction target path management table T5 is stored in the design information database 12. Each of numbers indicated in the symbol name item is given in such a manner that, as a margin of an optical path having a symbol name with the number is smaller, the number is smaller. Thus, symbol names illustrated in FIG. 20 are different from symbol names illustrated in FIG. 16.

A priority given to the section sec2 of the optical path P1 is the highest. Thus, paths that include the nodes of the section sec2 and have positive margins are detected as the optical paths P2, P3, and P4 and are registered in the reduction target path management table T5.

Then, the optical output power reduction adjuster 11c reduces and adjusts optical output power for the optical paths registered in the reduction target path management table T5. Specifically, the optical output power reduction adjuster 11c reduces and adjusts, for the start node n1 of the optical path P2, optical output power of WDM signal light to be transmitted in the optical path P2 in such a manner that the margin of the optical path P2 is maintained at a positive level and that the optical output power is equal to or higher than the output lower limit.

Similarly, the optical output power reduction adjuster 11c reduces and adjusts, for the start node n2 of the optical path P3, optical output power of WDM signal light to be transmitted in the optical path P3 in such a manner that the margin of the optical path P3 is maintained at a positive level and that the optical output power is equal to or higher than the output lower limit.

In addition, the optical output power reduction adjuster 11c reduces and adjusts, for the start node n2 of the optical path P4, optical output power of WDM signal light to be transmitted in the optical path P4 in such a manner that the margin of the optical path P4 is maintained at a positive level and that the optical output power is equal to or higher than the output lower limit.

FIG. 21 is a diagram illustrating an example of the amount of an increase in optical output power. In FIG. 21, an ordinate indicates optical output power (dBm/ch) and an abscissa indicates the number of times when the optical output power is increased. When the optical output power is to be increased and adjusted, the optical output power increase adjuster 11b increases the optical output power by a predetermined amount in a stepwise manner. For example, the optical output power increase adjuster 11b increases optical output power by levels of 0.5 dB in a stepwise manner.

FIG. 22 is a diagram illustrating an example of the amount of a reduction in optical output power. In FIG. 22, an ordinate indicates optical output power (dBm/ch) and an abscissa indicates the number of times when the optical output power is reduced. When the optical output power is to be reduced and adjusted, the optical output power reduction adjuster 11c reduces the optical output power by a predetermined amount in a stepwise manner. For example, the optical output power increase adjuster 11b reduces optical output power by 0.5 dB in a stepwise manner.

The processing functions of the network control apparatuses 1 and 10 described in the first and second embodiments may be achieved by a computer. In this case, the program in which details of processing to be executed by the functions of the storage control apparatus 1 and in which the details of the processing to be executed by the functions of the storage control apparatus 10 are described is provided. When the computer executes the program, the aforementioned processing functions are achieved in the computer.

The program in which the details of the processing are described may be recorded in a computer-readable recording medium. Examples of the computer-readable recording medium are a magnetic storage device, an optical disc, a magneto optical recording medium, and a semiconductor memory. Examples of the magnetic storage device are a hard disk device (HDD), a flexible disk (FD), and a magnetic tape. Examples of the optical disc are a DVD, a DVD-RAM, a CD-ROM, and a CD-RW. An example of the magneto optical recording medium is a magneto optical (MO) disk.

In the case where the program is distributed, a portable recording medium in which the program is recorded and that is a DVD, a CD-ROM, or the like may be on sale. In addition, the program may be stored in a storage device of a server computer and transferred from the server computer to another computer via a network.

The computer that is configured to execute the program may store, in a storage device of the computer, the program recorded in the portable recording medium or transferred from the server computer. Then, the computer reads the program from the storage device of the computer and executes the processes in accordance with the program. The computer may read the program directly from the portable recording medium and execute the processes in accordance with the program.

Every time the program is transferred from the server computer connected to the computer via the network, the computer may sequentially execute the processes in accordance with the received program. In addition, a part or all of the aforementioned processing functions may be achieved by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network control apparatus comprising:
a memory that stores route information indicating a route of a path established in a network; and
a processor coupled to the memory and configured to:
determine a target node of which signal output power is to be adjusted among a plurality of nodes on the route included in the route information, based on a signal quality between the plurality of nodes on the route; and
instructs the determined target node to adjust the signal output power.

2. The network control apparatus according to claim 1, wherein the processor is configured to:
calculate a margin by subtracting a signal-to-noise ratio limit of a terminal node from a signal-to-noise ratio of the terminal node;
instruct the target node to increase the signal output power for a first path, when the calculated margin for the first path is negative; and
instruct the target node to reduce the signal output power for a second path extending through a part of the first path, when the calculated margin for the second path is positive.

3. The network control apparatus according to claim 2, wherein the processor is configured to:
assign a plurality of priorities to a plurality of sections located between a plurality of nodes of the first path in such a manner that, as a signal quality of a section between the plurality of nodes of the first path is smaller, a higher priority is assign to the section;
determine, as the target node, a start node of a section located between the start node and another node and to which the highest priority has been assigned; and
instruct the start node to increase the output power of the signal to be transmitted in the first path until the margin of the first path becomes positive.

4. The network control apparatus according to claim 3, wherein the processor is configured to:
set, to an upper limit, the signal output power of a first start node of a first section located between the first start node and another node and to which a first priority has been assigned, when the margin of the first path reaches the upper limit before becoming positive upon an increase in the signal output power of the first start node of the first section;
determine, as the target node, a second start node of a second section located between the second start node and another node and to which a second priority that is lower by one level than the first priority has been assigned; and
instruct the second start node to increase the output power of the signal to be transmitted in the first path until the margin of the first path becomes positive.

5. The network control apparatus according to claim 2,
wherein the second path includes a section located between a plurality of nodes of which signal quality is the lowest among a plurality of signal qualities between the plurality of nodes of the first path.

6. The network control apparatus according to claim 2, wherein the processor is configured to:
determine, as the target node, a start node of the second path; and
instruct the start node of the second path to reduce the output power of the signal to be transmitted in the second path in such a manner that the margin of the second path is maintained at a positive level and that the signal output power is not lower than a lower limit of the signal output power.

7. The network control apparatus according to claim 1,
wherein the signal quality is an optical signal-to-noise ratio or a transmitting penalty.

8. The network control apparatus according to claim 1,
wherein the signal quality is a value obtained by summing an optical signal-to-noise ratio and a transmitting penalty.

9. The network control apparatus according to claim 1,
wherein the determined target node is configured to adjust the signal output power by controlling an amplifier for amplifying a signal level or a variable attenuator for variably attenuating the signal level.

10. A network control method to be executed by a processor included in a network control apparatus, the network control method comprising:
storing route information indicating a route of a path established in a network in a memory;
determining a target node of which signal output power is to be adjusted among a plurality of nodes on the route included in the route information, based on a signal quality between the plurality of nodes on the route; and
instructing the determined target node to adjust the signal output power.

11. The network control method according to claim 10, further comprises
calculating a margin by subtracting a signal-to-noise ratio limit of a terminal node from a signal-to-noise ratio of the terminal node,
wherein the instructing includes:
instructing the target node to increase the signal output power for a first path, when the calculated margin for the first path is negative, and
instructing the target node to reduce the signal output power for a second path extending through a part of the first path, when the calculated margin for the second path is positive.

12. The network control method according to claim 11, further comprises
assigning a plurality of priorities to a plurality of sections located between a plurality of nodes of the first path in such a manner that, as a signal quality of a section between the plurality of nodes of the first path is smaller, a higher priority is assign to the section, wherein
the determining includes determining, as the target node, a start node of a section located between the start node and another node and to which the highest priority has been assigned, and
the instructing includes instructing the start node to increase the output power of the signal to be transmitted in the first path until the margin of the first path becomes positive.

13. The network control method according to claim 12, further comprises
setting, to an upper limit, the signal output power of a first start node of a first section located between the first start node and another node and to which a first priority has been assigned, when the margin of the first path reaches the upper limit before becoming positive upon an increase in the signal output power of the first start node of the first section, wherein
the determining includes determining, as the target node, a second start node of a second section located between the second start node and another node and to which a second priority that is lower by one level than the first priority has been assigned, and
the instructing includes instructing the second start node to increase the output power of the signal to be transmitted in the first path until the margin of the first path becomes positive.

14. A non-transitory computer-readable recording medium storing a program that causes a processor included in a network control apparatus including a memory storing route information indicating a route of a path established in a network to execute a process, the process comprising:
determining a target node of which signal output power is to be adjusted among a plurality of nodes on the route included in the route information, based on a signal quality between the plurality of nodes on the route; and
instructing the determined target node to adjust the signal output power.
